(19) United States
(12) Patent Application Publication
(10) Pub. No.: US 2017/0182680 A1
(43) Pub. Date: Jun. 29, 2017

(54) CREATION OF INJECTION MOLDS VIA ADDITIVE MANUFACTURING

(71) Applicant: Cummins Inc., Columbus, IN (US)

(72) Inventor: Roger D. England, Loudon, TN (US)

(73) Assignee: Cummins Inc., Columbus, IN (US)

(21) Appl. No.: 15/129,762

(22) PCT Filed: Apr. 24, 2015
(86) PCT No.: PCT/US2015/027601

§ 371 Date: Sep. 27, 2016

Related U.S. Application Data
(60) Provisional application No. 61/986,500, filed on Apr. 30, 2014.

(51) Int. Cl. B29C 33/38; B29C 33/02; B33Y 80/00; B29C 45/40; B33Y 10/00; B33Y 50/02

(52) U.S. Cl. CPC B29C 33/3842; B33Y 10/00; B33Y 50/02; B33Y 80/00; B29C 45/40; B29C 33/02; B29K 2105/0067

(57) ABSTRACT

Methods of manufacturing an injection mold component are provided. The methods include printing a plurality of layers of a material into a near net shape mold of the injection mold component. The printing includes forming each layer in the plurality of layers upon another layer in the plurality of layers such that a volumetric part cavity is positioned between the plurality of layers. The volumetric part cavity corresponds to a coarse model of at least a portion of an injection moldable part. The method further includes removing material from the plurality of layers, whereby the volumetric part cavity expands to correspond to a precise model of the at least a portion of the injection moldable part and to form the injection mold component.

### CROSS-REFERENCE TO RELATED APPLICATIONS

The present application claims priority to U.S. Provisional Patent Application No. 61/986,500, filed Apr. 30, 2014 and the contents of which are incorporated herein by reference in the entirety.

### TECHNICAL FIELD

The present disclosure relates to methods and systems for manufacturing an injection mold.

### BACKGROUND

Manufacturing a significant number of precision parts generally requires production of a high quality mold. However, the process required to produce such a mold is typically labor intensive and highly technical. Accordingly, producing such a part by machining a mold can be cost prohibitive for many applications related to low production volume components. For example, when sourcing injection-molded plastics, the cost of the mold must be amortized over the expected life volume of the component. Thus, for a relatively complex component the lower the volume, the more expensive the mold and hence, to some extent, the more expensive the part.

Other techniques for manufacturing a part, such as by building a part that might otherwise be created via a mold, while possibly capable of producing a precision part, may not be susceptible to producing the part in a significant quantity. For example, processes such as additive manufacturing, facilitate production of a part by finely layering material in order to produce a part with a quality surface finish. In certain instances, the level of fineness required (i.e. the thickness of each layer) make the process impractical for producing numerous parts with a surface finish typically associated with a part produced by a high quality mold.

### SUMMARY

Various embodiments provide methods and systems for manufacturing an injection mold. Various embodiments provide a method of manufacturing an injection mold component that include printing a plurality of layers of a material into a near net shape mold of the injection mold component. The printing includes forming each layer in the plurality of layers upon another layer in the plurality of layers such that a volumetric part cavity is positioned between the plurality of layers. The volumetric part cavity corresponds to a coarse model of at least a portion of an injection moldable part. The method further includes removing material from the plurality of layers, whereby the volumetric part cavity expands to correspond to a precise model of the at least a portion of the injection moldable part and to form the injection mold component.

Various other embodiments relate to a method of manufacturing an injection mold. The method includes providing a three-dimensional computer model of an injection moldable part. A mold is designed based on the three-dimensional computer model of the injection moldable part. The mold has a first volumetric part cavity that is shaped so as to produce the injection moldable part using an injection molding process. The mold includes at least one mold component. A near net shape mold is then designed based on the mold. The near net shape mold has a second volumetric part cavity smaller than the first volumetric part cavity. The near net shape mold includes at least one near net shape mold component. The near net shape mold component is then printed using an additive manufacturing printer. Finally, the near net shaped mold component is machined to produce the mold component.

In particular embodiments, the injection mold component is a first injection mold component and the volumetric part cavity is a first volumetric part cavity and the method further includes coupling a second injection mold component to the first injection mold component. The second injection mold component includes a second volumetric part cavity. The second injection mold component is coupled to the first injection mold component such that the second volumetric part cavity engages the first volumetric part cavity to form a unitary part cavity corresponding to the injection moldable part. The method of manufacturing includes injecting a molten material into the unitary part cavity to form the injection moldable part, in accordance with particular embodiments. The method may also include removing the injection moldable part from the unitary part cavity. The method also includes, before printing the plurality of layers, obtaining a three-dimensional computer model of the injection moldable part, in accordance with particular embodiments. The method may also include generating a three-dimensional computer model of the near net shape mold. The three-dimensional computer model includes information concerning the plurality of layers and a plurality of machining pick-up points. In particular embodiments, the material includes a metal. The material may include a nickel superalloy. In particular embodiments, at least one layer in the plurality of layers is contoured to form at least one cooling channel. The injection moldable part may include an engine component. In particular embodiments, removing material includes removing 1 mm or less of each layer. The plurality of layers may include layers having variable thickness. Each layer in the plurality of layers may have the same thickness. At least one layer in the plurality of layers may have a variable thickness. In particular embodiments, the plurality of layers includes parallel layers. Printing includes printing with a three-dimensional printing machine, in accordance with particular embodiments. Removing material may include removing material with a computer numerically controlled machine.

The inventors have appreciated that injection molds may be manufactured to produce production quality parts, such as engine parts, in a rapid and cost effective manner by implementation of additive manufacturing techniques in tandem with subtractive manufacturing techniques. The inventors have further appreciated that injection molds can be created quickly using additive manufacturing with large step sizes. The surface of the mold that comes in contact with the finished part can have a small amount of stock added via the large step sizes in the layers produced by additive manufacturing. The added stock may be quickly removed via conventional subtractive machining, giving the required surface finish more quickly than machining the mold entirely or substantially entirely. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a flow diagram for a method of manufacturing an injection mold component, in accordance with example embodiments.

FIG. 2 illustrates a side view of a near net shape mold of the injection mold component, in accordance with example embodiments.

FIG. 3 illustrates a top view of the near net shape mold of FIG. 2.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive methods and systems for manufacturing an injection mold component. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

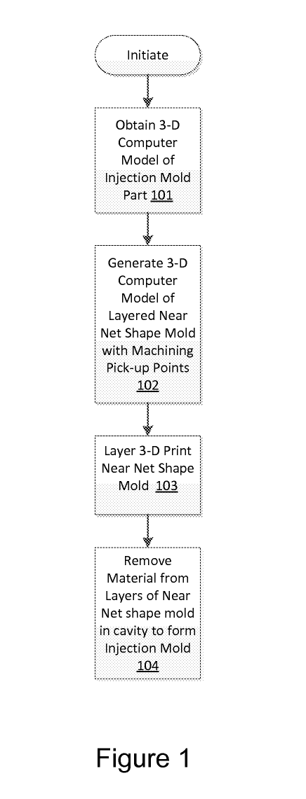

FIG. 1 illustrates a flow diagram for a method of manufacturing an injection mold component, in accordance with example embodiments. In a first process 101, a three-dimensional computer rendering of the part to be injection molded is obtained. In process 101, a three-dimensional computer rendering of a near net shape mold is generated based on the part of process 102. The near net shape mold is provided in the form of a plurality of layers having a volumetric part cavity recessed within the plurality of layers. The plurality of layers, which are formed by additive manufacturing, includes machining pick-up points identifying the extra material from each layer that needs to be removed from a portion of each layer that in order to form the final precise interior surface or mold cavity having the surface finish and size that will be used to injection mold the part. In example embodiments, the machining pick-up points may be identified such that a maximum distance is not exceeded between any two points. Accordingly, the near net shape mold formed provides a coarse model of the part to be injection molded and forms a volumetric cavity having a cavity volume that is less than the volume of the part to be machined. In accordance with particular embodiments, the thickness of each layer additively formed is determined based in part on the maximum energy available to cure each layer of material added via the additive manufacturing machine implemented.

In process 103, the near net shape mold is manufactured through an additive manufacturing technique. Additive manufacturing in accordance with example embodiments includes methods of creating an object by adding material to the object layer by layer. Additive manufacturing in accordance with example embodiments, includes, but is not limited to, three-dimensional printing, stereolithography, metal sintering or melting (e.g., selective laser sintering, direct metal laser sintering, selective laser melting, etc.), and other three-dimensional layering techniques. In process 104, extra material is removed from layers of the plurality of layers within the volumetric cavity. The extra material may be removed by a machining process, including but not limited to computer numerically controlled machining Accordingly the volumetric part cavity expands, upon removal of the extra material from the additively formed layers, to cause the expanded volumetric part cavity to correspond to a precise model of the cavity for the injection molded part. The cavity obtained via expansion leaves a mold surface that will operate as the contact surface of the finished part being injection molded to give the required surface finish of the part. The material removed is identified based off of pre-identified points corresponding to locations on the injection molded part. In example embodiments, two mold cavities may be formed by processes 101-104 and the molds may be joined, for example in an injection molded machine for injection of a mold material to form a part. The mold material includes a metallic material in particular embodiments. In particular embodiments, an injection channel is formed in the mold for introduction of molten material into the mold to form an injection molded part. In particular embodiments, an exhaust channel is formed in the mold for air exhaustion upon introduction of molten material into the mold. The injection channel and the exhaust channel extend from a peripheral portion of the mold into the cavity. In example embodiments, one or more channels may be formed in the mold for introduction of a cooling fluid. In particular embodiments, the cooling fluid channels are positioned adjacent the mold cavity and extend to an outer peripheral portion of the mold for injection of the cooling fluid. The cooling fluid channels follow the contour of the mold cavity having at least a portion of a layer disposed between the channel and the cavity, in accordance with particular embodiments. Forming the cooling fluid channels adjacent to the cavity and in a corresponding contour to the mold cavity in accordance with particular embodiments is advantageous because it allows the cooling channels to extend adjacent to cavity for a greater distance than a straight channel and thus, permits greater heat exchange from the molten material injected into the cavity to the cooling fluid flowing in the cooling channel. The increased heat exchange permits the molten material to be cooled and hardened into the injection molded part more quickly, thereby reducing production time. The cooling fluid channels are formed via the plurality of layers of the mold via additive manufacturing. Accordingly, the cooling fluid channels have a coarse surface that interfaces with the fluid formed by the distinct layers. The coarse surface of the cooling channels provides a surface roughness within the channel that causes increased turbulence in the flow of cooling fluid flowing through the cooling channels, which advantageously increases the cooling efficiency of the cooling passages.

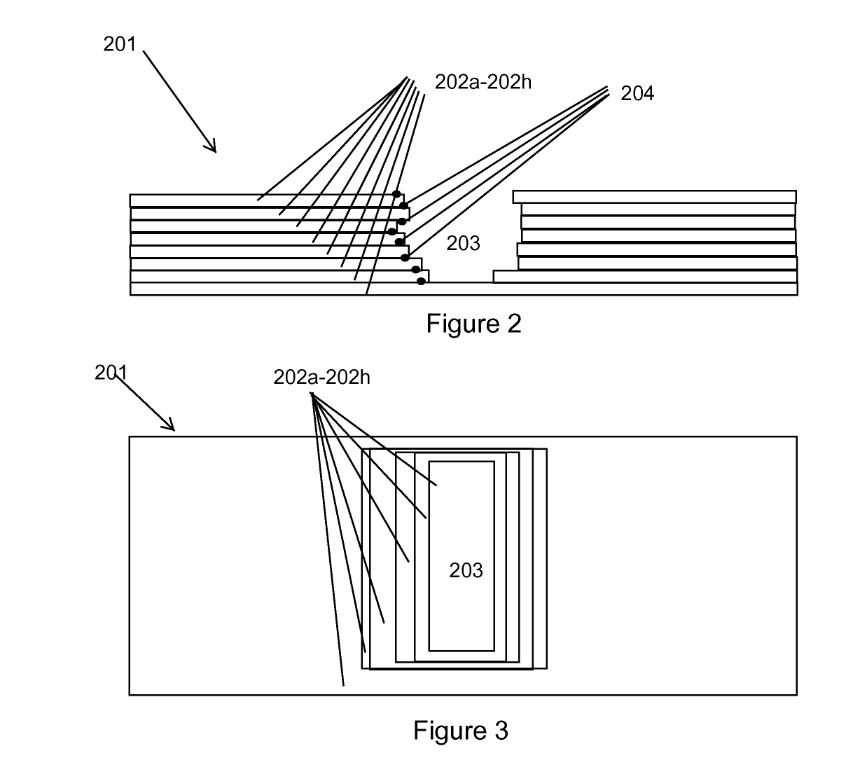

FIG. 2 illustrates a side view of a near net shape mold 201 of the injection mold component, in accordance with example embodiments. The near net shape mold 201 is composed of a plurality of layers 202a-202h stacked and formed on top of one another in accordance with example embodiments. The plurality of layers 202a-202h may have a uniform thickness or a variable thickness in accordance with example embodiments. The plurality of layers 202a-202h may each have a uniform thickness or may vary in thickness and may be planar or may be positioned in a plurality of planes. The plurality of layers 202a-202h form a volumetric cavity 203 that outlines a 3-D coarse model of the part to be formed by injection molding in the final injection mold formed from the near net shape mold 201. In an example embodiment, each of the plurality of layers 202a-202h of the near net shape mold 201 has a thickness that is larger than a geometric tolerance of a corresponding portion of the injection molded part. Because the near net shape mold 201 is later machined to a precise tolerance to form the final injection mold, the additive manufacturing process to form the plurality of layers 202a-202h of the near net shape mold 201 may utilize relatively large layer thicknesses. The thickness of the layers 202a-202h may be optimized to increase the efficiency of the entire process, including the additive process and the machining process in accordance with particular embodiments. For example, the thickness of the layers may be determined based in part on the maximum energy available to cure each layer of material added via the additive manufacturing machine implemented.

The plurality of layers 202a-202h include a plurality of machining pick-up points 204 identifying the portion of each layer that is to be removed via subtractive manufacturing or machining to expand the volumetric cavity 203 into a precise model of the at least a portion of the injection moldable part. In some embodiments, the pick-up points 204 include features formed in the volumetric cavity 203 that are used to define positions of features of the volumetric cavity 203 within orthogonal datum planes. For example, dimensions of the volumetric cavity 203 may be measured from the pick-up points 204 in order to ensure consistent measurements. Because the pick-up points 204 are formed in the volumetric cavity 203, the pick-up points 204 are also formed in the part to be molded. Accordingly, the pick-up points 204 of the part may be used to verify dimensions of the part. In addition, a jig or machine tool may locate against the pick-up points 204. The pick-up points 204 may also be used during a subsequent machining process to locate the part with respect to the machine tool.

FIG. 3 illustrates a top view of the near net shape mold of FIG. 2. As demonstrated in FIG. 3, the plurality of layers 202a-202h generally expands in a plane to form the volumetric cavity 203. In accordance with example embodiments, the plurality of layers 202a-202h may have a corresponding dimension in one or more direction and may also facilitate undercuts in the injection mold.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that, unless otherwise noted, any parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A method of manufacturing an injection mold component, the method comprising:
printing a plurality of layers of a material into a near net shape mold of the injection mold component, wherein printing includes forming each layer in the plurality of layers upon another layer in the plurality of layers such that a volumetric part cavity is positioned between the plurality of layers, the volumetric part cavity corresponding to a coarse model of at least a portion of an injection moldable part; and
removing material from the plurality of layers, whereby the volumetric part cavity expands to correspond to a precise model of the at least a portion of the injection moldable part and to form the injection mold component.

2. The method of manufacturing of claim 1, wherein the injection mold component is a first injection mold component and the volumetric part cavity is a first volumetric part cavity, and wherein the method further comprises coupling a second injection mold component to the first injection mold component, the second injection mold component including a second volumetric part cavity, the second injection mold component coupled to the first injection mold component such that the second volumetric part cavity engages the first volumetric part cavity to form a unitary part cavity corresponding to the injection moldable part.

3. The method of manufacturing of claim 2, further comprising injecting a molten material into the unitary part cavity to form the injection moldable part.

4. The method of manufacturing of claim 1, further comprising removing the injection moldable part from the unitary part cavity.

5. The method of manufacturing of claim 1, further comprising, before printing the plurality of layers, obtaining a three-dimensional computer model of the injection moldable part.

6. The method of manufacturing of claim 5, generating a three-dimensional computer model of the near net shape mold, the three-dimensional computer model including information concerning the plurality of layers and a plurality of machining pick-up points.

7. The method of manufacturing of claim 1, wherein the material includes a metal.

8. The method of manufacturing of claim 7, wherein the metal includes a nickel superalloy.

9. The method of manufacturing of claim 1, at least one layer in the plurality of layers is contoured to form at least one cooling channel.

10. The method of manufacturing of claim 1, wherein the injection moldable part includes an engine component.

11. The method of manufacturing of claim 1, wherein the plurality of layers includes layers having variable thickness.

12. The method of manufacturing of claim 1, wherein each layer in the plurality of layers has the same thickness.

13. The method of manufacturing of claim 1, wherein at least one layer has a variable thickness.

14. The method of manufacturing of claim 1, wherein the plurality of layers are parallel layers.

15. The method of manufacturing of claim 1, wherein printing includes printing with a three-dimensional printing machine.

16. The method of manufacturing of claim 1, wherein removing material includes removing material with a computer numerically controlled machine.

17. A method of manufacturing an injection mold, the method comprising:
providing a three-dimensional computer model of an injection moldable part;
designing, based on the three-dimensional computer model of the injection moldable part, a mold having a first volumetric part cavity, the first volumetric part cavity shaped so as to produce the injection moldable part using an injection molding process, the mold including at least one mold component;
designing, based on the mold, a near net shape mold, the near net shape mold having a second volumetric part cavity smaller than the first volumetric part cavity, the near net shape mold including at least one near net shape mold component;
printing, using an additive manufacturing printer, the at least one near net shape mold component; and
machining the at least one near net shaped mold component to produce the at least one mold component

18. The method of claim 17, wherein the at least one mold component includes first and second mold components, the first and second mold components being operably coupleable to form the mold.

19. The method of claim 17, wherein the printing includes applying and bonding successive layers of material.

20. The method of claim 19, wherein each of the successive layers of material have a thickness larger than a geometric tolerance of a corresponding portion of the injection moldable part.
